(19) United States
(12) Patent Application Publication
(10) Pub. No.: US 2002/0176257 A1
(43) Pub. Date: Nov. 28, 2002

(54) Lighting fixture assembly

(76) Inventors: John H. Cummings, Rancho Mirage, CA (US); Alan Fujii, Newport Beach, CA (US)

Correspondence Address: MYERS, DAWES & ANDRAS LLP, Suite 1150, 19900 MacArthur Blvd., Irvine, CA, 92612, US

(21) Appl. No.: 09/866,233

(22) Filed: May 25, 2001

(51) Int. Cl. F21V 21/00

(52) U.S. Cl. 362/391; 362/226; 439/389

(57) ABSTRACT

A lighting fixture assembly includes a unitary housing having a reflector, neck and wire receiving portion. Electrical circuits include electrically conductive strips housed in a circuit support comprising mating halves. A mid-portion is removed from one strip to form a modular electrical circuit that is coupled to a thermal cut-off device also housed in the circuit support which is disposed within the housing neck. The wire receiving portion includes semi-cylindrical walls with opposed gaps that define a path for receiving a power supply line. Piercing pins of the circuits protrude above the circuit support. An adapter includes a curved recess for receiving a power supply line and directing the line to make contact with the piercing pins. A removable cap is mated to the wire receiving portion to apply force onto the adapter, thereby causing the power supply line to be pierced by the pins.

### BACKGROUND OF THE INVENTION

1. Field of the Invention

The present invention relates generally to lighting fixtures and methods of manufacture.

2. Description of Prior Art and Related Information

Interior recessed lighting fixtures have typically required junction boxes, either attached to a side of the fixture or installed adjacent the fixture. The power supply for the fixture comes into the junction box where it is connected to the electrical leads extending from the fixture. If additional fixtures are to be electrically connected to the same circuit, the power distribution cables must also exit the junction box to the additional fixtures. Thus, it can be seen that the routing of power supply cables to a junction box from the fixture adds complexity and cost to the installation. In new construction, hanger bars, plaster frames, or other fixture supports must be installed prior to installing the fixture, and the drywall, plaster, or other wall and ceiling materials later applied. Cutouts must be then be cut in the finished wall or ceiling to expose the preinstalled fixtures.

If additional lighting fixtures are to be installed in existing structures, such as during remodeling, it is often necessary to feed new wires through walls and ceilings to the specific desired location of the new fixture. Typically, junction boxes, if not previously assembled to the fixture, must be installed in the ceiling or other surface adjacent the desired location of the new fixture. This is often difficult to do because of limited access once a structure has been built and walls and ceilings enclosed.

Additionally, in order to support the fixture, it is typically necessary to install hanger bars between joists and multi-directional plaster frames suspended between the hanger bars. Typical recessed lighting fixtures require an opening having a diameter of about 6 inches, which makes it difficult to install the captive hanger bars and multi-directional plaster frames in existing construction. In drop ceiling installations, it is necessary to provide support bars across the suspended panel in which the lighting fixture is to be installed. This requires that the fixture be installed on the panel prior to installing the panel in the supporting suspended framework. This requirement makes it difficult to install recessed fixtures in low clearance suspended ceilings.

Thus, it can be seen that with existing lighting fixtures it is necessary to wire the fixture to a power supply after installation of the fixture. The positioning of the electrical power supply cables is a particular problem in new construction, where only bare studs and joists exist to define rooms or other enclosed areas.

Also, conventional recessed interior lighting fixtures have been constructed for a specific bulb and voltage application. Such applications include, but are not limited to, low voltage halogen, mains or line voltage halogen, fluorescent, incandescent, high intensity discharge, pure sulfur, light emitting diode (LED) and other lighting arrangements. Generally, each different combination of voltage and bulb type have heretofore required a specifically designed fixture.

Therefore, a need presently exists for a recessed interior lighting fixture providing easier installation and connection to power supply wiring. Also, a need presently exists for a recessed lighting fixture which has a minimum number of parts and may be manufactured and assembled at reduced cost.

### SUMMARY OF THE INVENTION

The present invention provides structures and methods which overcome the deficiencies in the prior art.

In one aspect, a light fixture assembly is provided. The assembly comprises a unitary housing, an electrical circuit support, an electrical circuit and a cap. The unitary housing has a lamp receiving portion, a neck, and a wire receiving portion. The wire receiving portion preferably comprises a cylindrical portion with a pair of opposed gaps defining a path. The electrical circuit is disposed at least in part within the electrical circuit support. The electrical circuit comprises a piercing pin and a socket opposite to the piercing pin, both of which preferably protrude outwardly from the electrical circuit support. The cap is coupled to the wire receiving portion and movable to force a power supply line disposed in the wire receiving portion to contact the piercing pin. The cap is preferably screwed onto the wire receiving portion.

The assembly further comprises a thermal cut-off device coupled to the electrical circuit. The electrical circuit support comprises a pair of identical mating halves. The identical mating halves are configured to join such that the piercing pin and the socket of the electrical circuit protrude out from the halves. The cap comprises a downwardly extending boss which is preferably cylindrical.

In another aspect, a light fixture assembly is provided with an adapter for accommodating a particularly sized power supply line. The assembly comprises a housing, a first electrical circuit and a second electrical circuit disposed within the housing, and an adapter disposed at least in part within the housing. The first electrical circuit comprises a first piercing pin and a first lamp receiving socket. The second electrical circuit comprises a second piercing pin and a second lamp receiving socket. The adapter has a channel, or recess, configured to receive a power supply line with a first wire and a second wire. The channel is curved such that the first wire is aligned with the first piercing pin and the second wire is aligned with the second piercing pin.

The assembly further comprises a movable mounting member removably coupled to the housing and adapted to apply force on the adapter toward the piercing pins. The movable mounting member comprises a removable cap adapted to be screwed onto the housing. The removable cap further comprises a boss configured to abut the adapter when the removable cap is screwed onto the housing. The channel is defined on a bottom side of the adapter. The adapter further comprises a ridge on a top side corresponding to the channel, the ridge comprising a flat surface adapted for abutting the boss of the removable cap. The channel includes a curve.

In a further aspect, an adapter is provided for directing a power supply line through a lighting fixture. The power supply line may comprise a non-metallic sheath cable and/or a flexible metallic conduit, i.e. a metallic sheath cable. The power supply line includes a first wire and a second wire. The adapter comprises a body having a top side and a bottom side, a channel defined in the bottom side of the body, the channel having a curve, and a ridge on the top side of the body corresponding to the channel. The body comprises a circular periphery. The adapter further comprises a pair of legs protruding in opposite directions from the body. The power supply line comprises a flexible metallic conduit. The adapter further comprises a retaining mechanism for securing the flexible metallic conduit. In a preferred embodiment, the retaining mechanism comprises a pair of dividers, one extending from each leg transverse to the opposite directions of the legs.

A method for manufacturing a lighting fixture is also provided. The method comprises forming a unitary housing, providing a first electrically conductive strip with a first piercing pin, providing a second electrically conductive strip with a second piercing pin, providing a circuit support, holding the first electrically conductive strip and the second electrically conductive strip with the circuit support, disposing the circuit support with the electrically conductive strips in the unitary housing, and providing a mounting member that is movable to and from the first and second piercing pins. Providing a circuit support comprises forming identical mating halves.

The method further comprises removing a mid-portion of the second electrically conductive strip to form a first conductive member and a separate, second conductive member. With the mid-portion removed, a thermal cut-off device may be coupled to the first conductive member and the second conductive member. The thermal cut-off device is disposed in the circuit support. The method further comprises providing an adapter configured to receive a power line and adapted to be disposed in between the piercing pins and the mounting member.

A method is further provided for manufacturing a lighting fixture compatible with commercial and residential power supply lines. The method comprises providing a housing, providing a first electrical circuit, providing a second electrical circuit, disposing the first electrical circuit and the second electrical circuit in the housing, providing an adapter to receive a power supply line, configuring the adapter to be disposed adjacent to the first electrical circuit and the second electrical circuit, and providing a mounting member that is movable to apply force on the adapter toward the first electrical circuit and the second electrical circuit.

Providing an adapter to receive a power supply line comprises forming a channel in the adapter. Forming a channel in the adapter comprises curving the channel such that the power supply line received therein is directed through positions of the first electrical circuit and the second electrical circuit when the adapter is disposed adjacent to the first electrical circuit and the second electrical circuit. Providing an adapter to receive a power supply line comprises providing a first adapter to receive a first power line. The method further comprises providing a plurality of additional adapters, and configuring each additional adapter with a differently sized channel for receiving differently sized power supply lines.

The adapter may be formed with oppositely protruding legs. The power supply line comprises a coiled commercial power supply line, such as a flexible metallic conduit which includes wires disposed within a coiled metallic sheath. The method further comprises forming the adapter with at least one divider configured to fit between coils of the coiled commercial power supply line. Providing a second electrical circuit comprises removing a portion from an electrically conductive strip to form two separate conductive members, the method further comprising coupling a thermal cut-off member to the two conductive members.

The invention, now having been briefly summarized, may be better appreciated by the following detailed description.

### BRIEF DESCRIPTION OF THE DRAWINGS

FIG. 1 is a perspective view of a preferred lighting fixture assembly according to the invention;

FIG. 2 is an exploded view of the preferred lighting fixture assembly;

FIG. 3 is a perspective view of a preferred embodiment of a first electrical circuit;

FIG. 4 is a perspective view of a preferred embodiment of a second electrical circuit;

FIG. 5 is an exploded view in part of a circuit holder with the corresponding electrical circuits;

FIG. 6 is an axial cross-sectional view of the apparatus;

FIG. 7 is a bottom perspective view of an adapter according to the invention;

FIG. 8 is a top perspective view of the adapter;

FIG. 9 is a top plan view of the assembly with a cap removed to show the adapter receiving a wire with hidden view lines;

FIG. 10 is a cross-sectional view of a top portion of the assembly with the cap mounted and rotated into operative position; and

FIG. 11 is a perspective view of an alternate adapter for receiving metallic covered wires for commercial use.

### DETAILED DESCRIPTION OF THE PREFERRED EMBODIMENTS

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

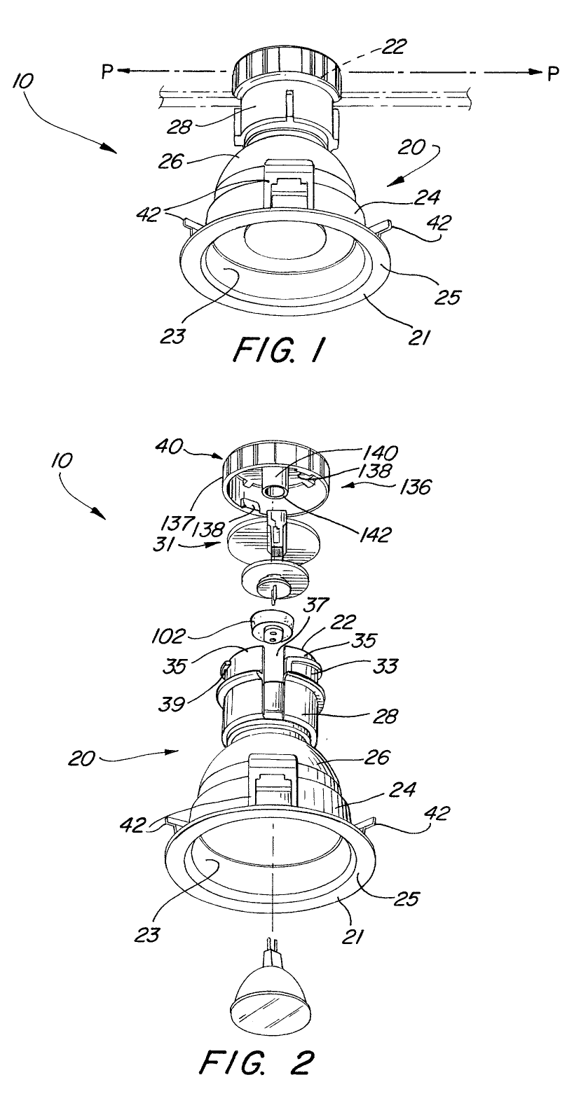

A preferred embodiment of a light fixture assembly is illustrated In FIGS. 1 and 2, and designated generally by the reference numeral 10. The light fixture assembly, or simply apparatus, 10 includes a housing 20 which comprises a unitary, or integral, structure in the preferred embodiment. As used herein, “unitary” means comprising a single piece, or comprising several pieces inseparably coupled together, for example by molding, adhering, or other methods, such that removal of any piece cannot be accomplished without damage. In an alternative embodiment, the housing 20 may comprise separate modules coupled together.

The housing 20 includes a bottom end 21, a top end 22, an interior side 23 and an exterior side 24. An annular trim 25 at the bottom end 21 is integral with a lamp receiving portion 26 that is sized to receive a light bulb. The lamp receiving portion 26 preferably includes a reflective inner surface which may be a reflective coating on the inner surface of the lamp receiving portion 26, or a reflective insert having a shape generally matching that of the lamp receiving portion and affixed thereto. In the preferred embodiment, the reflector portion 26 is shaped as a dome. Integral with the reflector portion 26 is a neck 28 which houses a circuit support 31. A cylindrical portion, or wire receiving portion, 33 extends upwardly from the neck 28 and includes a pair of opposed curved walls 35. The walls 35 are spaced apart to define opposing gaps, or tracks, 37 for receiving a power supply line. The gaps 37 thus define an axis, or path, “P” in which a power supply line is placed. The walls 35 include external threads 39 configured to mate with an internal guide member of a removable cap 40.

Spring clips 42 are coupled to the exterior side 24 of the housing for retaining the apparatus 10 in a recess or opening, e.g. in a ceiling. A variety of other clips and spring mechanisms may be used to retain the apparatus 10 in an opening.

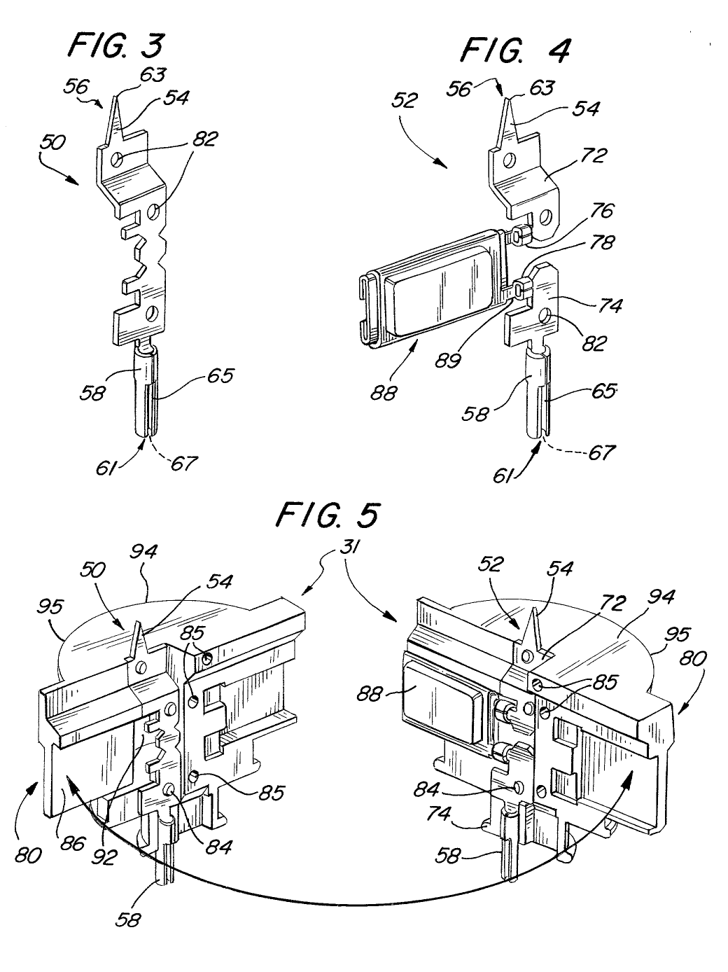

FIGS. 3 and 4 are perspective views of a first, unitary electrical circuit 50 and a second, modular electrical circuit 52, respectively. The circuits 50, 52 are configured to provide electrical connection between a power supply line and a lamp inserted in the light fixture. In the preferred embodiment, the first circuit 50 comprises a unitary, elongated strip composed of an electrically conductive material. The second circuit 52 comprises a substantially similar structure as that of the first circuit 50 except that a mid-portion is removed, preferably by stamping. Each circuit 50, 52 includes a piercing pin 54 at an upper end 56 and a socket 58 at a lower end 61. In FIG. 3, the piercing pin 54 and socket 58 are integral with the strip 50. The sockets 58 as illustrated are adapted to together engage the two pins of a lamp, such as a halogen lamp, having a standard two pin connector. The sockets 58 may be modified if necessary for further lamp connectors.

In FIGS. 3 and 4, each piercing pin 54 has a pointy tip 63 configured to pierce the insulation of power supply lines of varying types and sizes. As will be described in further detail below, an adapter enables the apparatus 10 to accommodate such varying power supply lines. Each socket 58 preferably comprises an open-ended cylinder with longitudinal slots 65. The socket 58 defines a bore 67 sized to receive a pin, or terminal, of a lamp.

With a mid-portion removed, the second circuit 52 thus comprises a top conductive member, or first member, 72 and a separate bottom conductive member, or second member, 74 as shown in FIG. 4. The first member 72 comprises the piercing pin 54 and includes a first, upper tab 76. The second member 74 comprises the socket 58 and includes a second, lower tab 78.

FIG. 5 illustrates each circuit 50, 52 housed in a corresponding mating half 80. The identical mating halves 80 are configured to be joined to collectively form the circuit support 31. Each circuit 50, 52 is coupled to their respective mating half 80 by aligning apertures 82 of the circuits 50, 52, as shown in FIGS. 3 and 4, with projections 84 of the mating halves 80, shown in FIG. 5. Each mating half 80 also includes bores 85 configured to receive the projections 84 of the opposing half 80. Each mating half 80 further includes a recess, or cavity, 86 sized and configured to receive a thermal cut-off device 88, shown also in FIG. 4. The mating halves 80 are preferably composed of a high temperature, injection moldable thermoplastic material that is not electrically conductive, such as a polyetherimide resin. The first and second electrical circuits 50, 52 are preferably pressed on to the corresponding halves 80 before joining the halves 80 together. Thus, each of the halves 80, after molding and subassembly, have a continuous elongated strip 50 secured to the plastic body.

In the preferred embodiment, a single thermal cut-off device 88 is provided for switching an electrical circuit in response to temperature. The cut-off device 88 is disposed in the mating half 80 which holds the modular circuit 52, and more specifically, interposed between the first conductive member 72 and the second conductive member 74. As shown more clearly in FIG. 4, the cut-off device 88 is electrically coupled to the modular circuit 52 by contacts 89 mating with the tabs 76, 78. As an example and not by way of limitation, the thermal cut-off device 88 may comprise a KLIXON® switch produced by Texas Instruments which opens in response to sensing a temperature above a predetermined value.

For purposes of clarity in FIG. 5, the second electrical circuit 52 is shown with the mid-portion already removed in order to form the two separate conductive members 72, 74. In the preferred method of assembly, however, an elongated integral strip 50 is placed in each of the halves 80 after which a single thermal cut-off device 88 is placed in only one of the halves 80. It will be appreciated that the cut-off device 88 may be arbitrarily placed in either of the halves 80 prior to joining since, at this point, the elongated strips 50 are identical.

With the thermal cut-off device 88 positioned within one of the mating halves 80, a mid-portion of the elongated strip disposed in contact with the thermal cut-off device 88 is removed by inserting a punch through a window 92 provided in the mating half structure 80 and severing the mid-portion from the elongated strip. After removal of the mid-portion, an otherwise integral electrical circuit is converted into the modular electrical circuit 52 with the separate first and second electrically conductive members 72, 74 thus formed.

The halves 80 are then joined by ultrasonic welding, adhesives, or any other assembly technique of choice, to form the circuit support 31. Each conductive member 72, 74 is rigidly embedded within the circuit support 31. Also, the thermal cut-off device 88 is advantageously positioned in fixed relationship with respect to the electrically conductive tabs 76, 78 of the conductive members 72, 74. Importantly, the internally disposed components of the first and second electrically conductive circuits 50, 52 provide the structural strength for support of the piercing pins 54 and the sockets 58.

Thus, the first electrical circuit 50 provides an electrically conductive path from its respective piercing pin 54 to its respective socket 58 through a single, unitary structure. The second electrical circuit 52, which is interruptible, or capable of being opened if a predetermined operating temperature is exceeded, comprises an electrically conductive path from its respective piercing pin 54 through the first electrically conductive member 72, to the upper tab 76, thence through the thermal cut-off device 88 to the lower tab 78 of the second electrically conductive member 74, and through the second electrically conductive member 74 to the socket 58. This arrangement provides important advantages when the fixture is arranged for use with high temperature lamps such as halogen lamps. However, the thermal cut-off device 88 may not be required for other lighting applications such as non-halogen incandescent bulb and fluorescent lamp arrangements. If not required, both the first and second electrical circuits may be formed as single, one-piece elongated strips, as described above with respect to the first electrical circuit 50.

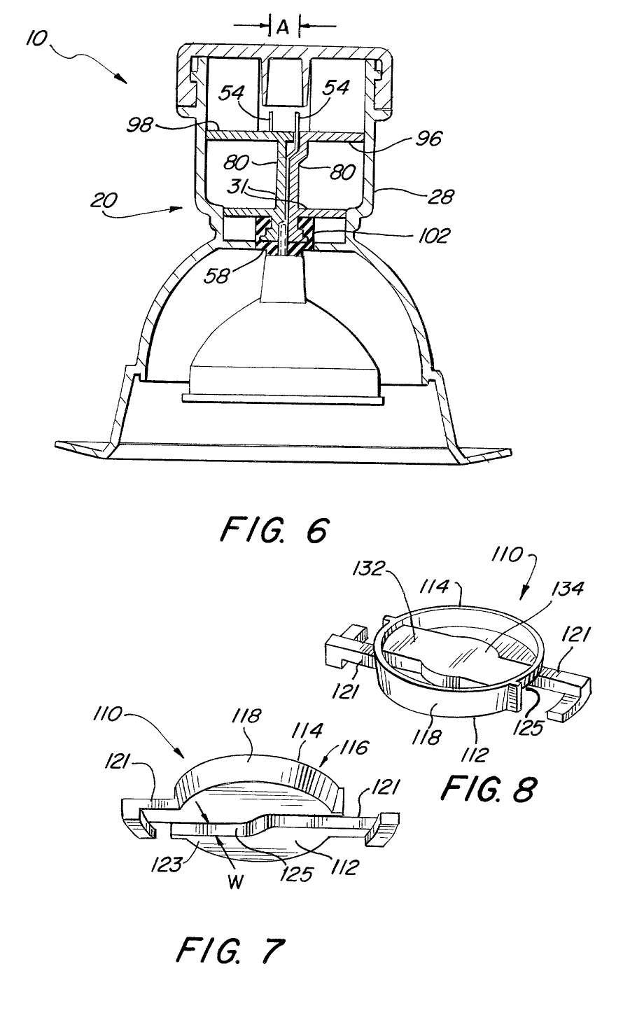

Each mating half 80 also comprises a top portion 94 with a semi-circular periphery 95. When joined as shown in FIG. 6, the mating halves 80 collectively form a disk 96 having a top surface 98 adapted for supporting a power supply line and the adapter as described further below. The piercing pins 54 protrude above the disk 96 in order to pierce the insulation of a power supply line disposed thereon.

After assembly of the circuit support 31 as described above, the circuit support 31 is inserted into the housing 20 which may be formed of the same high temperature, electrically nonconductive thermoplastic material as the mating halves. As shown in FIG. 6, the circuit support 31 is disposed in the neck 28 of the housing 20 and may be secured in fixed position with respect to the housing 20 by mechanical devices such as cooperating tabs and grooves, screws, pins or, preferably by ultrasonically welding selected mutually abutting surfaces of the two members whereby the circuit support 31 and the housing 20 form a single, unitary structure with two separate electrical circuits, one of which may contain a thermal cutout switch, embedded within the single structure.

In FIGS. 1 and 6, the apparatus 10 also includes a stopper 102 fitted within the neck 28 of the housing 20. By snugly surrounding the sockets 58 protruding beneath the circuit support 31, the stopper 102 reduces the heat flow from the lamp receiving portion 26 into the neck 28 and the wire receiving portion 33. The stopper 102 further provides support for the sockets 58. In FIG. 6, the piercing pins 54 are spaced apart from each a distance of “A” along an axis transverse to the path “P”, shown in FIG. 1, in which a power supply line would extend. Alternatively stated, the piercing pins 54 are spaced apart from each a distance of “A” along an axis perpendicular to an axis defined by the opposing gaps 37. In order for the piercing pins 54 to contact the wires insulated within a power supply line, the power supply line itself must be wide enough to fit snugly in the path defined by the gaps 37. Thus, the power supply line must have a width such that when it extends through the gaps 37, the wires insulated within would be disposed above the piercing pins 54, thereby enabling contact when the power supply line is pressed downward into the pins 54.

If a power supply line is more narrow than the width of the gaps 37, the range of side-to-side room provided by the gaps 37 prevents the power supply line from being automatically aligned such that its wires are disposed above the piercing pins 54. In FIGS. 7 and 8, an adapter 110 is provided for accommodating a particularly sized power supply line that otherwise would not be appropriately disposed on the disk 96. In particular, the adapter 110 is configured to carry a power supply line with a specific width and to align it appropriately with the piercing pins 54.

The adapter 110 has a bottom side 112 and a top side 114. The adapter 110 comprises a main body 116 with a circular rim 118 such that the main body 116, with its circular periphery, fits within the top cylindrical portion 31 of the housing 20. A pair of legs 121 extend outwardly from the main body 116 in opposite directions. The legs 121 are configured to extend through the gaps 37 of the housing cylindrical portion 31, thereby keeping the adapter 110 in a fixed position by preventing its rotation. The main body 116 includes a bottom adapter surface 123 adapted to abut the top surface 98 of the disk 96. A channel, or recess, 125 is defined in the bottom side 112 of the main body 116. It will be noted that the legs 121 further define the channel 125. The channel 125 has a width “W” to receive a particularly sized power supply line.

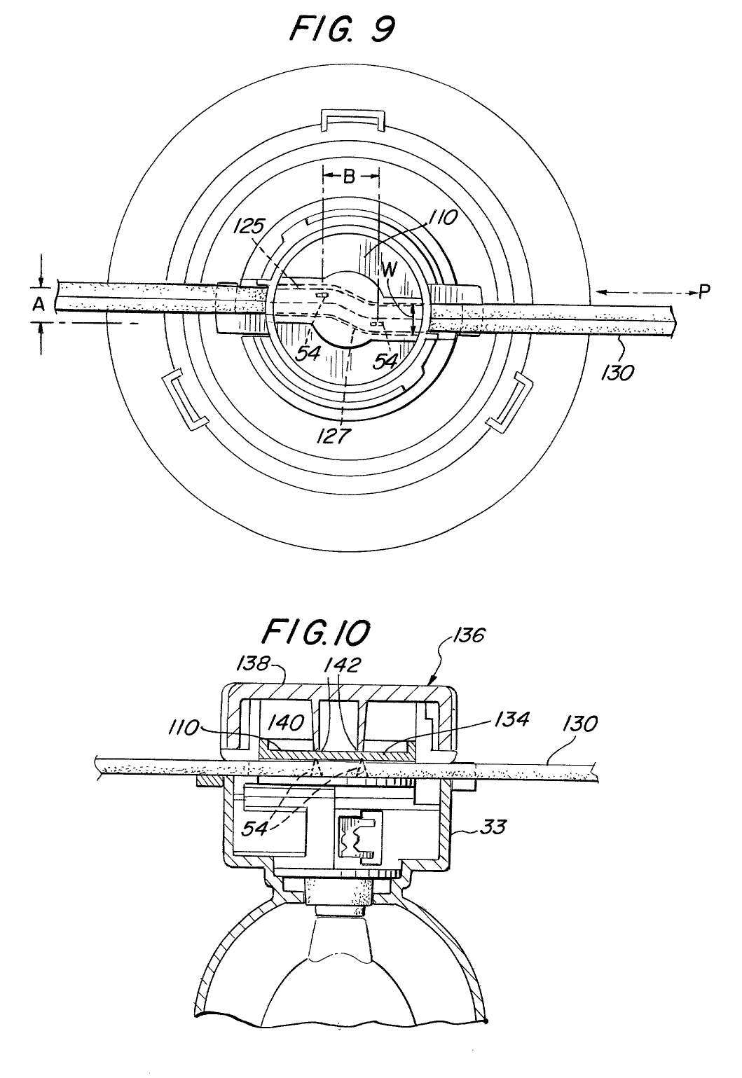

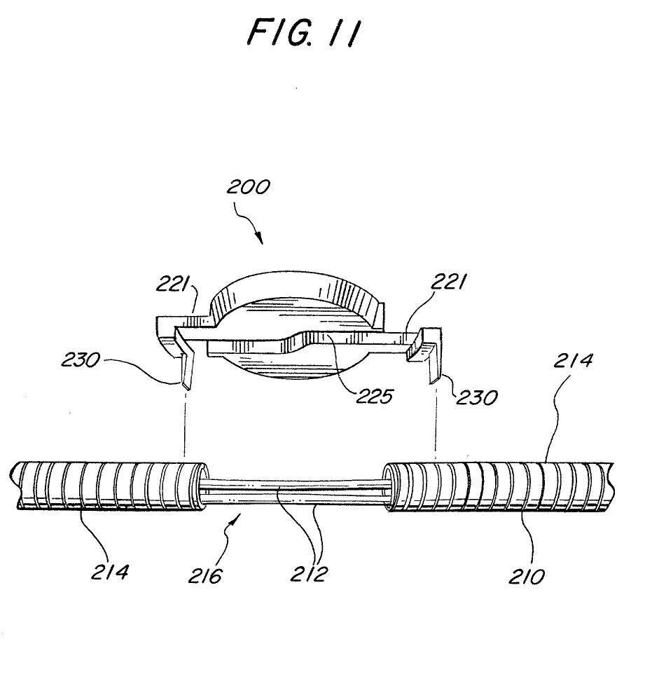

FIG. 9 is a top plan view of the apparatus 10 in part, with the adapter 110 shown in hidden view lines to illustrate the matching features between the adapter 110 and the rest of the apparatus 10. The channel 125 of the adapter 110 includes a curve 127 corresponding to the latitudinal spacing “A” of the piercing pins 54. It will be noted that the piercing pins 54 are also spaced apart a distance of “B” along the “P” axis. This longitudinal spacing “B” provides room for a power supply line to be curved by the channel 125 as it extends through the adapter 110.

Though the width “W” of recess 125 is not manually adjustable (in a preferred embodiment designed to reduce cost), it will be appreciated that several types of adapters 110 may be manufactured with varying widths in order to accommodate differently sized power supply lines. Thus, if a desired power supply line is more narrow, for example, the channel 125 may have a more narrow width “W”, but a wider curve 127 in order to align the line with the piercing pins 54. Alternatively, if a desired power supply line is wider, the channel 125 may be provided with a greater width “W”, and a lesser curve 127.

The power supply line 130 is inserted into the channel 125. The adapter 110 is then placed into the cylindrical housing portion 33 with the power supply line 130 facing the pins 54. The adapter 110 includes a ridge 132 on the top side 114 that is opposite to the channel 125 defined in the bottom side 112. The ridge 132 includes a top ridge surface 134 that is substantially flat. To apply pressure to the adapter 110 toward the piercing pins 54, a movable pressure member is provided. The ridge surface 134 provides an area at least substantial enough for abutting the movable pressure member.

In FIGS. 1 and 10, the apparatus 10 further comprises a movable pressure member 136. In the preferred embodiment, the movable pressure member 136 comprises a removable cap adapted to biasedly contact the adapter disposed in the cylindrical housing portion 33. The cap 136 includes a rim 137 with internal threads 138 configured to mate with the external threads 39 of the cylindrical portion 33 for forcibly moving the cap 136 in a direction toward the pins 54. In the preferred embodiment, the cap 136 comprises a boss 140 extending downwardly from a cap disk 138. The boss 140 preferably comprises a cylinder with an annular ring 142 formed at a distal end.

As the cap 136 is screwed onto the cylindrical housing portion 33, the annular ring 142 is brought into abutting contact with the ridge surface 134 of the adapter 110. With the power supply line extending through the adapter 110, applying the cap 136 pushes the power supply line against the pins 54 with sufficient force to pierce the insulation surrounding individual wires contained within. When the cap 136 is fully seated, the annular ring 142 is maintained in biased abutting contact against the ridge surface 134 of the adapter 110. This assures positive engagement of the pins 54 with respective wires in the power supply line, which wires have been redirected by the adapter channel 125, shown in FIG. 7. Thus, the cap 136 is movable to ultimately force the power supply line 130 onto the piercing pins 54.

The manufacturability of the apparatus 10 will be appreciated as the components may be manufactured with constant dimensions with the exception of the adapter 110, which is relatively inexpensive to produce. Thus, flexibility in accommodating various power supply lines is provided without having to increase complexity in manufacturing. It will be appreciated that the simplicity of manufacturing the apparatus 10 drastically saves expenses.

FIG. 11 illustrates in exploded view an alternate adapter 200 configured for receiving a commercial power supply line 210. The power supply line 210 is illustrated as flexible metallic conduit and is representative of conventional lines used in commercial buildings. The line 210 includes a pair of wires 212 insulated by a coiled metallic sheath 214. A portion of the coiled sheath 214 is removed for providing access to the wires 212. The exposed portions 216 of the wires 212 are then inserted into a channel 225 of the adapter 200. Adjacent coiled sheath portions 214 may also be disposed in the channel 225.

A pair of legs 221 extends in opposite directions. The adapter 200 includes a retaining mechanism 230 for securing the commercial power supply line 210. In a preferred embodiment, the retaining mechanism 230 comprises a vertical wall, or divider, 230 extending transversely from each leg 221. The wall 230 is configured so as to fit in the space between adjacent coils of the coiled sheath 214, thereby holding the commercial power supply line 210 in place. In an alternative embodiment, the retaining mechanism may comprise clamps that each include a ridge configured to fit between the coils of the metallic sheath.

In certain applications, it may be desirable to form the adapter with multiple channels. For example, in addition to the primary channel which receives the wires of the power supply line, a secondary channel may be formed for receiving a grounding wire. The secondary channel would preferably be spaced apart from the primary channel so as to separate the grounding wire from the wires of the power supply line. In the adapter 200 for commercial power supply lines, a current carrying bus bar may be provided in a secondary channel and adapted for contacting the separated ends of the coiled metallic sheath 214 so as to provide continuity. Furthermore, in some applications, the channel 225 may alternatively be formed as two, separate channels, each receiving an individual wire 212 of the power supply line 210.

In applications for use with high power, high temperature lamps, the apparatus 10 may also comprise a heat shield providing a dead air insulating space between the lamp and the housing. In such case, the heat shield may include the disclosure provided by U.S. Pat. No. 5,738,436 to Cummings, which is incorporated by reference as though fully set forth herein.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what incorporates the essential idea of the invention.

What is claimed is:

1. A light fixture assembly, comprising:
a unitary housing having a lamp receiving portion, a neck, and a wire receiving portion;
an electrical circuit support;
an electrical circuit disposed at least in part within the electrical circuit support, the electrical circuit comprising a piercing pin and a socket opposite to the piercing pin; and
a cap coupled to the wire receiving portion and movable to force a power supply line disposed in the wire receiving portion to contact the piercing pin.

2. The assembly of claim 1, wherein the wire receiving portion comprises a cylindrical portion with a pair of opposed gaps defining a path.

3. The assembly of claim 1, further comprising a thermal cut-off device coupled to the electrical circuit.

4. The assembly of claim 1, wherein the electrical circuit support comprises a pair of identical mating halves.

5. The assembly of claim 4, wherein the identical mating halves are configured to join such that the piercing pin and the socket of the electrical circuit protrude out from the halves.

6. The assembly of claim 1, wherein the cap comprises a downwardly extending boss.

7. A light fixture assembly, comprising:
a housing;
a first electrical circuit disposed within the housing, the first electrical circuit comprising a first piercing pin and a first lamp receiving socket;
a second electrical circuit disposed within the housing, the second electrical circuit comprising a second piercing pin and a second lamp receiving socket; and
an adapter disposed at least in part within the housing, the adapter having a channel configured to receive a power supply line with a first wire and a second wire, the channel being curved such that the first wire is aligned with the first piercing pin and the second wire is aligned with the second piercing pin.

8. The assembly of claim 7, further comprising a movable mounting member removably coupled to the housing and adapted to apply force on the adapter toward the piercing pins.

9. The assembly of claim 8, wherein the movable mounting member comprises a removable cap adapted to be screwed onto the housing.

10. The assembly of claim 9, wherein the removable cap further comprises a boss configured to abut the adapter when the removable cap is screwed onto the housing.

11. The assembly of claim 10, wherein the channel is defined on a bottom side of the adapter, the adapter further comprising a ridge on a top side opposite to the channel, the ridge comprising a flat surface adapted for abutting the boss of the removable cap.

12. The assembly of claim 7, wherein the channel includes a curve.

13. An adapter for directing a power supply line through a lighting fixture, the power supply line including a first wire and a second wire, the adapter comprising:
a body having a top side and a bottom side;
a channel defined in the bottom side of the body, the channel having a curve; and
a ridge on the top side of the body opposite to the channel.

14. The adapter of claim 13, wherein the body comprises a circular periphery.

15. The adapter of claim 13, further comprising a pair of legs protruding in opposite directions from the body.

16. The adapter of claim 13, wherein the power supply line comprises a flexible metallic conduit, the adapter further comprising a retaining mechanism to secure the flexible metallic conduit.

17. The adapter of claim 16, wherein the retaining mechanism comprises a divider extending from each leg transverse to the opposite directions of the legs.

18. A method for manufacturing a lighting fixture, the method comprising:
forming a unitary housing;
providing a first electrically conductive strip with a first piercing pin;
providing a second electrically conductive strip with a second piercing pin;
providing a circuit support;
holding the first electrically conductive strip and the second electrically conductive strip with the circuit support;
disposing the circuit support with the electrically conductive strips in the unitary housing; and
providing a mounting member that is movable to and from the first and second piercing pins.

19. The method in claim 18, wherein providing a circuit support comprises forming identical mating halves.

20. The method in claim 18, further comprising removing a mid-portion of the second electrically conductive strip to form a first conductive member and a separate, second conductive member.

21. The method in claim 20, further comprising coupling a thermal cut-off device to the first conductive member and the second conductive member.

22. The method in claim 21, further comprising disposing the thermal cutoff device in the circuit support.

23. The method in claim 18, further comprising providing an adapter configured to receive a power line and adapted to be disposed in between the piercing pins and the mounting member.

24. A method for manufacturing a lighting fixture compatible with commercial and residential power supply lines, the method comprising:
providing a housing;
providing a first electrical circuit;
providing a second electrical circuit disposing the first electrical circuit and the second electrical circuit in the housing;
providing an adapter to receive a power supply line;
configuring the adapter to be disposed adjacent to the first electrical circuit and the second electrical circuit; and
providing a mounting member that is movable to apply force on the adapter toward the first electrical circuit and the second electrical circuit.

25. The method in claim 24, wherein providing an adapter to receive a power supply line comprises forming a channel in the adapter.

26. The method in claim 25, wherein forming a channel in the adapter comprises curving the channel such that the power supply line received therein is directed through positions of the first electrical circuit and the second electrical circuit when the adapter is disposed adjacent to the first electrical circuit and the second electrical circuit.

27. The method in claim 24, wherein providing an adapter to receive a power supply line comprises providing a first adapter to receive a first power line, the method further comprising:
providing a plurality of additional adapters; and
configuring each additional adapter with a differently sized channel for receiving differently sized power supply lines.

28. The method in claim 24, further comprising forming the adapter with oppositely protruding legs.

29. The method in claim 24, wherein the power supply line comprises a coiled commercial power supply line, the method further comprising forming the adapter with at least one divider configured to fit between coils of the coiled commercial power supply line.

30. The method in claim 24, wherein providing a second electrical circuit comprises removing a portion from an electrically conductive strip to form two separate conductive members, the method further comprising coupling a thermal cut-off member to the two conductive members.
